(19) United States
(12) Patent Application Publication
(10) Pub. No.: US 2009/0322552 A1
(43) Pub. Date: Dec. 31, 2009

(54) REMOTE CONTROL DEVICE AND REMOTE CONTROL METHOD

(75) Inventors: Masanori MACHIMURA, Tokyo (JP); Tetsujiro Kondo, Tokyo (JP); Hiroto Kimura, Tokyo (JP); Yoshiaki Oikawa, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/474,956

(22) Filed: May 29, 2009

(30) Foreign Application Priority Data
Jun. 30, 2008 (JP) 2008-170365

(51) Int. Cl. G08C 19/00; G05B 19/02

(52) U.S. Cl. 340/825.72; 340/825.22; 340/825.69; 348/734

(57) ABSTRACT

A remote control device includes a polyhedral housing, an operation section provided on each of a plurality of surfaces of the housing, a main operation surface determination signal generation section for generating a determination signal for setting one of the surfaces in a predetermined direction as a main operation surface irrespective of an orientation of the housing, a transmission section for transmitting a remote control signal, and a control section for setting the main operation surface on the basis of the determination signal, generating a remote control signal for a control function assigned to the operation section provided on the main operation surface in response to an operation of the operation section, and causing the transmission section to transmit the remote control signal.

### BACKGROUND OF THE INVENTION

1. Field of the Invention

The present invention relates to a remote control device and a remote control method. More specifically, the present invention relates to a remote control device formed in the shape of a polyhedron with operation sections provided on a plurality of surfaces. The remote control device and method define a surface in a predetermined direction as a main operation surface irrespective of the orientation of a housing to transmit a remote control signal for a control function assigned to an operation section provided on the main operation surface in response to an operation of the operation section, so that various operations are easily performed by remote control by changing the main operation surface.

2. Description of the Related Art

To perform a plurality of operation targets with a limited number of buttons, operation buttons of remote control devices in the past were each provided with a plurality of functions to enable one of the functions according to a specified operation target, allowing remote control operation of the plurality of operation targets through the common use of the operation buttons.

To operate a desired operation target using this type of remote control device, an operation for selecting a desired operation target from a plurality of operation targets and an operation for causing the selected operation target to perform a desired operation are performed in combination. Attempts have been made to facilitate the operation for selecting a desired operation target from a plurality of operation targets and the operation for causing the selected operation target to perform desired operation. Japanese Unexamined Patent Application Publication No. 2004-282586 (JP-A-2004-282586) discloses a remote control transmitter that displays a menu of appliances, a group menu representing combinations of functions of an appliance for remote control provided on the outer peripheral surface of a cylindrical object, and individual functions belonging to a selected group menu provided on the outer peripheral surface of a cylindrical object. These menus allow easy understanding of the entirety of a plurality of group menus for a desired appliance and the correspondence between individual functions belonging to a predetermined group.

Japanese Unexamined Patent Application Publication No. Hei 07-59170 (JP-A-Hei 07-59170) discloses a remote control device that determines the orientation angle of a remote control transmitter on the basis of the angular speeds of the remote control transmitter in the vertical and horizontal directions to transmit changes in orientation angle of the remote control transmitter as a code. JP-A-Hei 07-59170 also discloses moving a cursor on a displayed menu on the basis of a transmitted code.

### SUMMARY OF THE INVENTION

To operate a desired operation target by remote control using the remote control transmitter disclosed in JP-A-2004-282586 which displays an appliance menu, a group menu and a menu of individual functions for a selected group menu, however, one selects the desired operation target from the appliance menu, selects a group menu containing a desired function, and selects the desired function from the individual functions belonging to the selected group menu, which may be troublesome.

With the remote control device disclosed in JP-A-Hei 07-59170 in which a cursor is moved on a displayed menu in accordance with changes in orientation angle of a remote control transmitter, one changes the orientation angle of the remote control transmitter such that a desired menu is selected, which may hinder easy selection of the desired menu. To perform an operation for selecting a desired operation target from a plurality of operation targets and an operation for causing the selected operation target to perform desired operation, one operates the remote control transmitter to change the orientation angle of the remote control transmitter for each of the operations.

Therefore, it is desirable to provide a remote control device and a remote control device allowing various operations to be easily performed by remote control.

According to a first embodiment of the present invention, there is provided a remote control device including: a polyhedral housing; an operation section provided on each of a plurality of surfaces of the housing; a main operation surface determination signal generation section for generating a determination signal for setting one of the surfaces in a predetermined direction as a main operation surface irrespective of an orientation of the housing; a transmission section for transmitting a remote control signal; and a control section for setting the main operation surface on the basis of the determination signal, generating a remote control signal for a control function assigned to the operation section provided on the main operation surface in response to an operation of the operation section, and causing the transmission section to transmit the remote control signal.

According to the embodiment of the present invention, the housing of the remote control device is formed in the shape of a polyhedron such as a regular tetrahedron or a regular hexahedron, and provided with an operation section on a plurality of surfaces, for example each surface, of the housing. The main operation surface determination signal generation section generates a determination signal for setting one of the surfaces in a predetermined direction as a main operation surface irrespective of the orientation of the housing. The main operation surface may be a surface that is most easily operable by a user, of the plurality of surfaces, and may be a top surface or a surface facing the user, for example. That is, the main operation surface determination signal generation section generates a signal allowing the top surface or the surface facing the user to be determined as the main operation surface irrespective of the orientation of the housing. The main operation surface is determined on the basis of the determination signal so as to enable control functions assigned to the operation section provided on the main operation surface. When an operation button on the operation section provided on the main operation surface is operated, a remote control signal indicating a command allowing execution of the control function assigned to the operation button is generated and transmitted as an infrared signal or a radio wave.

Therefore, the main operation surface is changed by changing the orientation of the remote control device, allowing various operations to be easily performed by remote control by using an operation section on a desired surface selected from the operation sections provided on the plurality of operation surfaces.

The surfaces other than the main operation surface may be classified into function-enabled surfaces and function-disabled surfaces with reference to a position of the main operation surface to transmit a remote control signal for a control function assigned to the operation section provided on a surface classified as a function-enabled surface in response to an operation of the operation section.

Further, classification into function-enabled surfaces and function-disabled surfaces may be performed in accordance with a control function assigned to the operation section provided on the main operation surface to transmit a remote control signal for a control function assigned to the operation section provided on a surface classified as a function-enabled surface in response to an operation of the operation section. In addition, a control function assigned to the operation section provided on a surface classified as the function-enabled surface may be changed in accordance with a control function assigned to the operation section provided on the main operation surface.

According to a second embodiment of the present invention, there is provided a remote control method including the steps of: generating a determination signal for setting one of surfaces of a polyhedral housing in a predetermined direction as a main operation surface irrespective of an orientation of the housing; setting the main operation surface on the basis of the determination signal and generating a remote control signal for a control function assigned to an operation section provided on the main operation surface in response to an operation of the operation section; and transmitting the generated remote control signal.

### BRIEF DESCRIPTION OF THE DRAWINGS

FIG. 1 shows the appearance of a remote control device;

FIG. 2 is a developed view showing operation surfaces of the remote control device;

FIG. 3 shows the configuration of the remote control device;

FIG. 4A illustrates the configuration of a main operation surface determination signal generation section, showing a case where the gravity is utilized using an acceleration sensor;

FIG. 4B illustrates the configuration of the main operation surface determination signal generation section, showing a case where the gravity is utilized using an inclination sensor;

FIG. 4C illustrates the configuration of the main operation surface determination signal generation section, showing a case where the gravity is utilized using a ball sensor;

FIG. 4D illustrates the configuration of the main operation surface determination signal generation section, showing a case where the space brightness is utilized;

FIG. 4E illustrates the configuration of the main operation surface determination signal generation section, showing a case where the contact state is utilized;

FIG. 5 is a flowchart showing an operation of a control section;

FIG. 6 is a flowchart showing different operation of the control section;

FIG. 7 shows the relationship between main functions and sub-functions;

FIG. 8 is a flowchart showing an operation for selectively enabling the sub-functions;

FIG. 9 shows the appearance of a different remote control device;

FIG. 10 is a developed view showing operation surfaces of the remote control device; and

FIG. 11 shows the configuration of the different remote control device.

### DESCRIPTION OF THE PREFERRED EMBODIMENTS

An embodiment of the present invention will be described below with reference to the drawings. A remote control device according to the embodiment of the present invention includes a housing in the shape of a polyhedron such as a tetrahedron or a hexahedron in which operation sections are disposed on a plurality of surfaces of the housing.

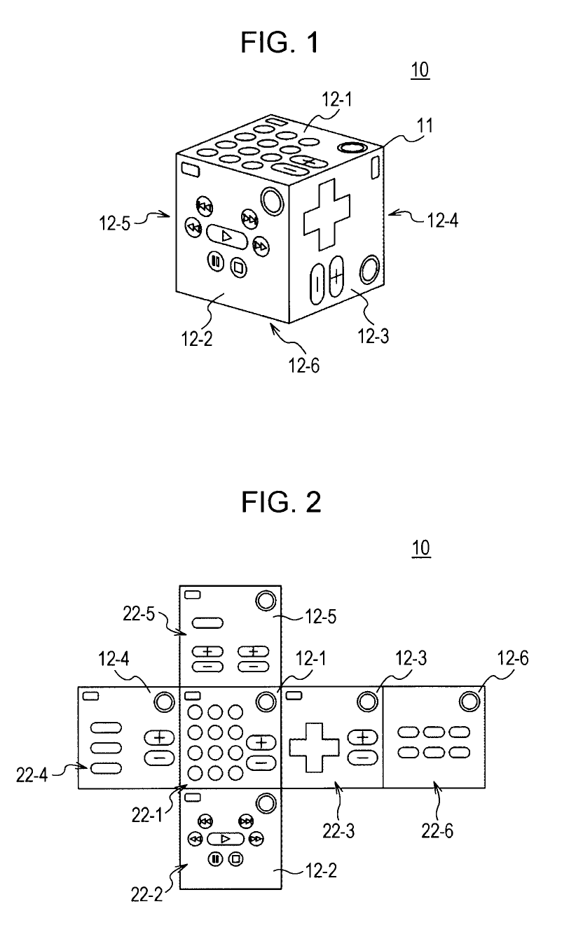

FIG. 1 illustrates a remote control device 10 including a regular tetrahedral housing 11 with operation buttons disposed on the six surfaces of the housing 11. The surfaces of the housing 11 are respectively referred to as operation surfaces 12-1 to 12-6, each provided with an operation section assigned with control functions. The control functions are grouped so that the control functions belonging to each group are assigned to each operation section.

FIG. 2 is a developed view showing the operation surfaces 12-1 to 12-6 of the remote control device 10. The operation surface 12-1 is used to change channels of a television set, for example. The operation surface 12-1 is provided with an operation section 22-1 including a channel-up button, a channel-down button and numeric buttons. The control functions assigned to the operation section 22-1 are referred to as “channel operation functions”.

The operation surface 12-2 is used to operate a digital versatile disc (DVD) device, for example. The operation surface 12-2 is provided with an operation section 22-2 including a playback button, a stop button, a pause button, a fast-forward button and a fast-reverse button. The control functions assigned to the operation section 22-2 are referred to as “DVD operation functions”.

The operation surface 12-3 is used to navigate through the menus of a television set, for example. The operation surface 12-3 is provided with an operation section 22-3 including a cross-shaped key and a determination button. The control functions assigned to the operation section 22-3 are referred to as “menu navigation functions”.

The operation surface 12-4 is used to adjust audio from a television set, for example. The operation surface 12-4 is provided with an operation section 22-4 including a volume-up button, a volume-down button and a sound quality mode selection button. The control functions assigned to the operation section 22-4 are referred to as “audio adjustment functions”.

The operation surface 12-5 is used to adjust video from a television set, for example. The operation surface 12-5 is provided with an operation section 22-5 including an image quality mode selection button, a brightness adjustment button and a color adjustment button. The control functions assigned to the operation section 22-5 are referred to as “video adjustment functions”.

The operation surface 12-6 is used to change input/output of a television set, for example. The operation surface 12-6 is provided with an operation section 22-6 including an input terminal switching button and an output terminal switching button. The control functions assigned to the operation section 22-6 are referred to as “input/output switching functions”.

The respective operation sections on the operation surfaces 12-1 to 12-6 each have a power button. The operation surfaces 12-1 to 12-6 have transmission sections 52-1 to 52-6, respectively, for transmitting a remote control signal.

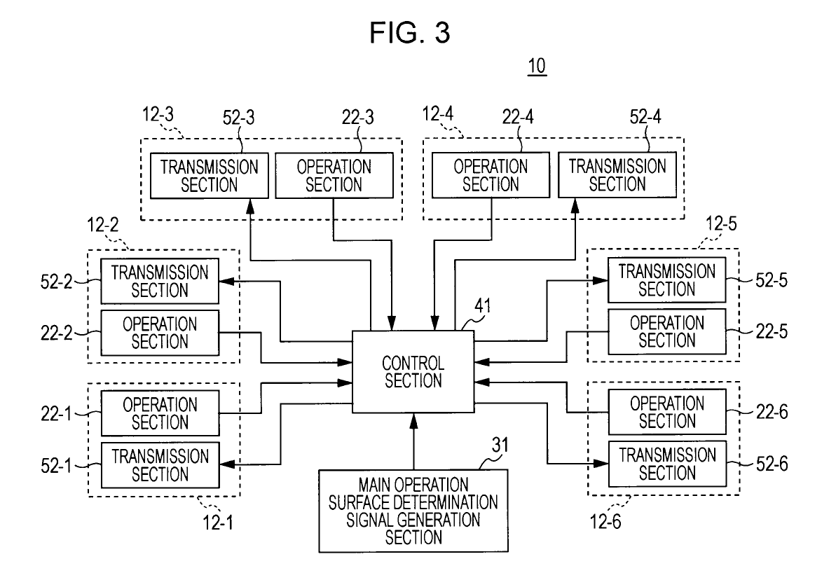

FIG. 3 shows the configuration of the remote control device. The operation sections 22-1 to 22-6 each supply an operation signal according to an operation by a user to a control section 41.

A main operation surface determination signal generation section 31 generates a determination signal for setting one of the plurality of operation surfaces 12-1 to 12-6 as a main operation surface. The main operation surface may be an operation surface that is the most easily operable by the user, of the plurality of operation surfaces. For example, when the remote control device 10 is operated while it is placed on a table, the operation surface that is most easily operable by the user is in general a top surface of the remote control device 10. Thus, the main operation surface determination signal generation section 31 generates a determination signal allowing determination of the top surface of the remote control device 10.

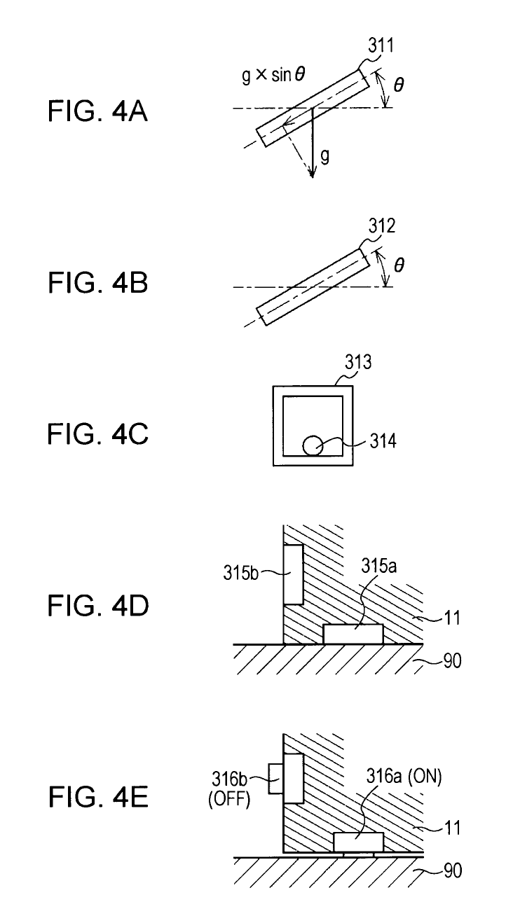

FIGS. 4A to 4E show exemplary configurations of the main operation surface determination signal generation section 31. The main operation surface determination signal generation section 31 generates a determination signal utilizing gravity, space brightness and contact state, for example. In the case where gravity is utilized, the main operation surface determination signal generation section 31 includes an acceleration sensor, an inclination sensor or a ball sensor.

In the case where an acceleration sensor is used, as shown in FIG. 4A, an acceleration sensor 311 capable of detecting gravitational acceleration is used to generate, as a determination signal, a sensor signal indicating an acceleration (g×sinθ) according to a gravitational acceleration g and an inclination θ of the acceleration sensor 311. The determination signal allows determination of the direction of gravity, making it possible to set a surface positioned opposite the direction of gravity (the top surface) as the main operation surface.

In the case where an inclination sensor is used, as shown in FIG. 4B, a sensor signal according to an inclination θ of an inclination sensor 312 is output as a determination signal. The determination signal also allows determination of the direction of gravity, making it possible to set a surface positioned opposite the direction of gravity (the top surface) as the main operation surface.

In the case where a ball sensor is used, as shown in FIG. 4C, a ball sensor including a sensor housing 313 having an internal space analogous to the housing 11 of the remote control device 10 and a ball 314 provided in the internal space is used to generate, as a determination signal, a sensor signal indicating which surface the ball 314 is on. The determination signal allows determination of a bottom surface of the housing 11, making it possible to set a surface opposite the bottom surface (the top surface) as the main operation surface.

In the case where the space brightness is utilized, an illumination sensor is provided on each surface of the housing 11 of the remote control device 10. When the remote control device 10 is placed on a table 90, as shown in FIG. 4D, the brightness detected by an illumination sensor 315a provided on the bottom surface of the housing 11 of the remote control device 10 becomes less than the brightness detected by an illumination sensor 315b provided on another surface, allowing detection of the bottom surface and the top surface opposite the bottom surface. Thus, sensor signals from the illumination sensors provided on the respective surfaces are used as a determination signal. The determination signal allows determination of the bottom surface of the housing 11, making it possible to set a surface opposite the bottom surface (the top surface) as the main operation surface.

In the case where the contact state is utilized, a contact switch is provided on each surface of the housing 11 of the remote control device 10. When the remote control device 10 is placed on a table 90, as shown in FIG. 4E, a contact switch 316a provided on the bottom surface of the housing 11 of the remote control device 10 is pressed by the table 90. In this event, the contact switch 316a is brought from the OFF state to the ON state, for example, while a contact switch 316b provided on a lateral surface is kept in the OFF state, allowing detection of the bottom surface and the top surface opposite the bottom surface. Thus, sensor signals from the contact switches provided on the respective surfaces are used as a determination signal. The determination signal allows determination of the bottom surface of the housing 11, making it possible to set a surface opposite the bottom surface (the top surface) as the main operation surface.

The control section 41 shown in FIG. 3 determines which surface is the main operation surface on the basis of the determination signal from the main operation surface determination signal generation section 31, generates a remote control signal for the control functions assigned to the operation section provided on the main operation surface in response to an operation of the operation section, and supplies the remote control signal to the transmission sections 52-1 to 52-6.

The transmission sections 52-1 to 52-6 include an infrared light emitting diode, for example, and convert the remote control signal supplied from the control section 41 into an infrared signal for output.

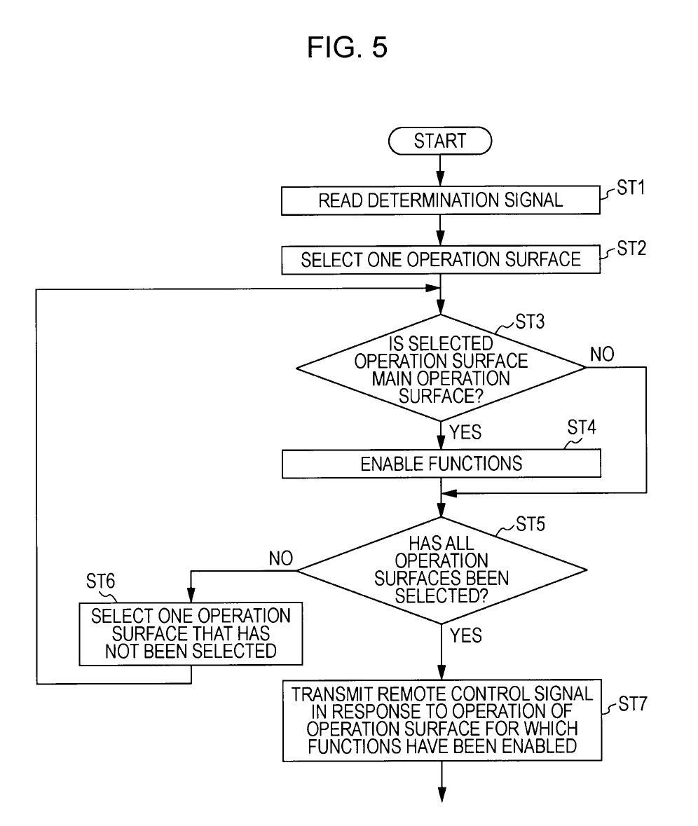

FIG. 5 is a flowchart showing an operation of the control section 41. In step ST1, the control section 41 reads a determination signal from the main operation surface determination signal generation section 31, and proceeds to step ST2.

In step ST2, the control section 41 selects one operation surface. The control section 41 selects one of the plurality of operation surfaces 12-1 to 12-6, and proceeds to step ST3.

In step ST3, the control section 41 determines whether or not the selected operation surface is the main operation surface If the selected operation surface is the main operation surface (the top surface of the housing 11) as determined on the basis of the determination signal, the control section 41 proceeds to step ST4. If the selected operation surface is not the main operation surface, the control section 41 proceeds to step ST5.

In step ST4, the control section 41 enables the functions assigned to the selected operation surface. That is, the control section 41 defines the selected operation surface as an operation surface for which a remote control signal for the control functions is transmitted in response to an operation by the user, and proceeds to step ST5.

In step ST5, the control section 41 determines whether or not all the operation surfaces have been selected. If there remain any operation surfaces yet to be selected, the control section 41 proceeds to step ST6. If all the operation surfaces have been selected, the control section 41 proceeds to step ST7.

In step ST6, the control section 41 selects one of the operation surfaces yet to be selected, and returns to step ST3.

In step ST7, the control section 41 transmits a remote control signal in response to an operation of the operation surface for which the functions have been enabled. That is, when an operation button on the operation section provided on the operation surface for which the functions have been enabled is operated, the control section 41 generates a remote control signal indicating a command allowing execution of the control function assigned to the operated operation button. Then, the control section 41 causes the operation sections 52-1 to 52-6 to transmit the generated remote control signal.

By determining which surface is the main operation surface and enabling only the functions assigned to the operation surface determined as the main operation surface as described above, a remote control signal will not be transmitted even if an operation button provided on an operation surface other than the main operation surface is operated, allowing execution of only the control functions assigned to the operation section provided on the main operation surface.

By changing the orientation of the remote control device 10 such that a desired operation surface is the top surface, only the control functions assigned to the operation section provided on the desired operation surface may be enabled. Therefore, a desired operation target may be operated by remote control in an easy and simple manner without performing an operation for selecting the desired operation target through a menu screen or operating a switch for selecting the desired operation target.

While the operation shown in FIG. 5 enables only the functions assigned to the main operation surface, it is also conceivable to enable the functions assigned to other surfaces in addition to the functions assigned to the main operation surface. In this case, more control functions may be executed efficiently by operating the operation sections provided on a plurality of operation surfaces without changing the orientation of the remote control device 10. In this case, the control section 41 classifies the surfaces other than the main operation surface into function-enabled surfaces and function-disabled surfaces with reference to the position of the main operation surface to generate a remote control signal for the control functions assigned to the operation section provided on a surface classified as a function-enabled surface in response to an operation of the operation section.

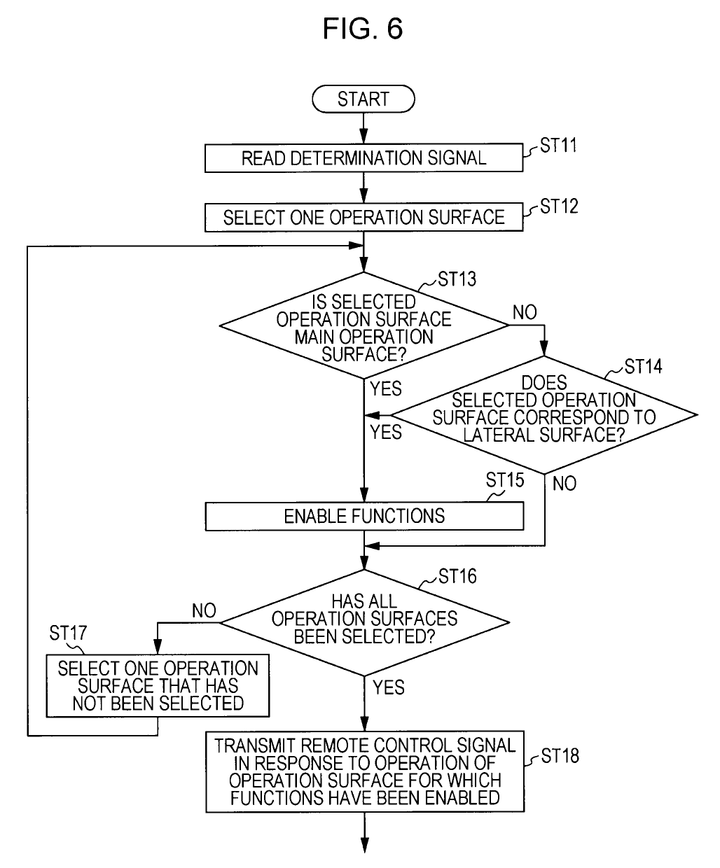

FIG. 6 is a flowchart showing a different operation of the control section 41. In the different operation, the surfaces other than the main operation surface are classified into function-enabled surfaces and function-disabled surfaces to generate a remote control signal for the control functions assigned to the operation section provided on a surface classified as a function-enabled surface in response to an operation of the operation section.

In step ST11, the control section 41 reads a determination signal from the main operation surface determination signal generation section 31, and proceeds to step ST12.

In step ST12, the control section 41 selects one operation surface. The control section 41 selects one of the plurality of operation surfaces 12-1 to 12-6, and proceeds to step ST13.

In step ST13, the control section 41 determines whether or not the selected operation surface is the main operation surface. If the selected operation surface is not the main operation surface (the top surface of the housing 11) as determined on the basis of the determination signal, the control section 41 proceeds to step ST14. If the selected operation surface is the main operation surface as determined on the basis of the determination signal, the control section 41 proceeds to step ST15.

In step ST14, the control section 41 determines whether or not the selected operation surface corresponds to a lateral surface. When the main operation surface is assumed to be the top surface as discussed above, operation surfaces adjacent to the main operation surface are assumed to be lateral surfaces. Thus, if it is determined that the selected operation surface corresponds to a lateral surface, that is, the selected operation surface is adjacent to the main operation surface, the control section 41 proceeds to step ST15. If it is determined that the selected operation surface does not correspond to a lateral surface, that is, the selected operation surface is not adjacent to the main operation surface, the control section 41 proceeds to step ST16.

In step ST15, the control section 41 enables the functions assigned to the selected operation surface. That is, the control section 41 defines the selected operation surface as an operation surface for which a remote control signal for the control functions is transmitted in response to an operation by the user, and proceeds to step ST16.

In step ST16, the control section 41 determines whether or not all the operation surfaces have been selected. If there remain any operation surfaces yet to be selected, the control section 41 proceeds to step ST17. If all the operation surfaces have been selected, the control section 41 proceeds to step ST18.

In step ST17, the control section 41 selects one of the operation surfaces yet to be selected, and returns to step ST13.

In step ST18, the control section 41 transmits a remote control signal in response to an operation of the operation surface for which the functions have been enabled. That is, when an operation button on the operation section provided on the operation surface for which the functions have been enabled is operated, the control section 41 generates a remote control signal indicating a command allowing execution of the control function assigned to the operated operation button. Then, the control section 41 causes the operation sections 52-1 to 52-6 to transmit the generated remote control signal.

By determining which surface is the main operation surface and classifying the surfaces other than the main operation surface into function-enabled surfaces and function-disabled surfaces with reference to the position of the main operation surface as described above, a remote control signal for a control function assigned to an operation button may be transmitted in response to an operation of the operation button on the operation section provided on the main operation surface (the top surface of the housing) and the surfaces adjacent to the main operation surface (the lateral surfaces of the housing), for example. Thus, the operation sections provided on the lateral surfaces may be used in addition to the operation section provided on the top surface, allowing various operations to be performed by remote control without changing the orientation of the remote control device 10. Because the control functions assigned to the operation surface corresponding to the bottom surface, which is not adjacent to the main operation surface, are not enabled, a remote control signal will not be transmitted by erroneously operating an operation button on the bottom surface, for example when the remote control device 10 is placed on a table.

Further, the control section 41 may classify the surfaces other than the main operation surface into function-enabled surfaces and function-disabled surfaces in accordance with the control functions assigned to the operation section provided on the main operation surface to generate a remote control signal for the control functions assigned to the operation section provided on a surface classified as a function-enabled surface in response to an operation of the operation section. The control functions assigned to the main operation surface are referred to as “main functions”, and the control functions assigned to the surfaces other than the main operation surface are referred to as “sub-functions”.

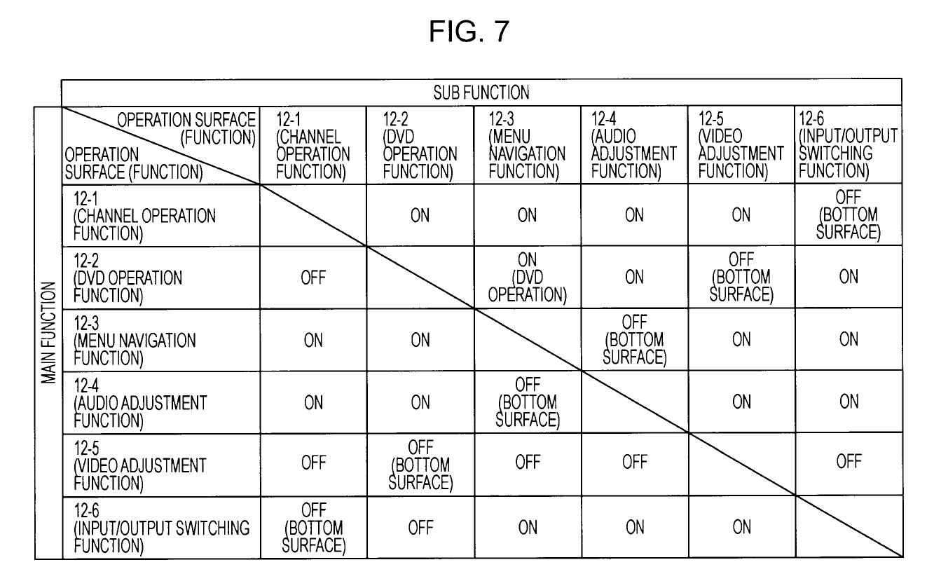

FIG. 7 shows the relationship between the main functions and the sub-functions. When the operation surface 12-1 corresponds to the top surface and is set as the main operation surface, the channel operation functions assigned to the operation section on the operation surface 12-1 are defined as the main functions. The control functions assigned to the operation sections on the operation surfaces 12-2 to 12-5, which are positioned adjacent to the operation surface 12-1, are defined as the sub-functions, and are enabled (in the ON state). The control functions assigned to the operation surface 12-6, which is positioned opposite the operation surface 12-1 and thus corresponds to the bottom surface, are disabled (in the OFF state).

When the operation surface 12-2 corresponds to the top surface and is set as the main operation surface, the DVD operation functions assigned to the operation section on the operation surface 12-2 are defined as the main functions. Because the channel of a television set is not changed while operating a DVD device, the channel operation functions assigned to the operation section on the operation surface 12-1, which is positioned adjacent to the operation surface 12-2, are disabled (in the OFF state). The control functions assigned to the operation sections on the operation surfaces 12-3, 12-4 and 12-6, which are positioned adjacent to the operation surface 12-2, are enabled (in the ON state). The control functions assigned to the operation surface 12-5, which is positioned opposite the operation surface 12-2 and thus corresponds to the bottom surface, are disabled (in the OFF state). The menu navigation functions assigned to the operation section provided on the operation surface 12-3 allow menu navigation associated with DVD operations.

When the operation surface 12-3 corresponds to the top surface and is set as the main operation surface, the menu navigation functions assigned to the operation section on the operation surface 12-3 are defined as the main functions. The control functions assigned to the operation sections on the operation surfaces 12-1, 12-2, 12-5 and 12-6, which are positioned adjacent to the operation surface 12-3, are defined as the sub-functions, and are enabled (in the ON state). The control functions assigned to the operation surface 12-4, which is positioned opposite the operation surface 12-3 and thus corresponds to the bottom surface, are disabled (in the OFF state).

When the operation surface 12-4 corresponds to the top surface and is set as the main operation surface, the audio adjustment functions assigned to the operation section on the operation surface 12-4 are defined as the main functions. The control functions assigned to the operation sections on the operation surfaces 12-1, 12-2, 12-5 and 12-6, which are positioned adjacent to the operation surface 12-4, are defined as the sub-functions, and are enabled (in the ON state). The control functions assigned to the operation surface 12-3, which is positioned opposite the operation surface 12-4 and thus corresponds to the bottom surface, are disabled (in the OFF state).

When the operation surface 12-5 corresponds to the top surface and is set as the main operation surface, the video adjustment functions assigned to the operation section on the operation surface 12-5 are defined as the main functions. When the channel or the input source is changed to switch a display screen while performing video adjustment by adjusting the image quality or the brightness, for example, it may be difficult to perform video adjustment. Therefore, the control functions assigned to the operation sections on the operation surfaces 12-1, 12-3, 12-4 and 12-6, which are positioned adjacent to the operation surface 12-5, are disabled (in the OFF state). The control functions assigned to the operation surface 12-2, which is positioned opposite the operation surface 12-5 and thus corresponds to the bottom surface, are also disabled (in the OFF state).

When the operation surface 12-6 corresponds to the top surface and is set as the main operation surface, the input/output switching functions assigned to the operation section on the operation surface 12-6 are defined as the main functions. Because DVD operations are not performed while changing the input/output for a television set, the DVD operation functions assigned to the operation section on the operation surface 12-2, which is positioned adjacent to the operation surface 12-6, are disabled (in the OFF state). The control functions assigned to the operation sections on the operation surfaces 12-3 to 12-5, which are positioned adjacent to the operation surface 12-6, are defined as the sub-functions, and are enabled (in the ON state). The control functions assigned to the operation surface 12-6, which is positioned opposite the operation surface 12-1 and thus corresponds to the bottom surface, are disabled (in the OFF state).

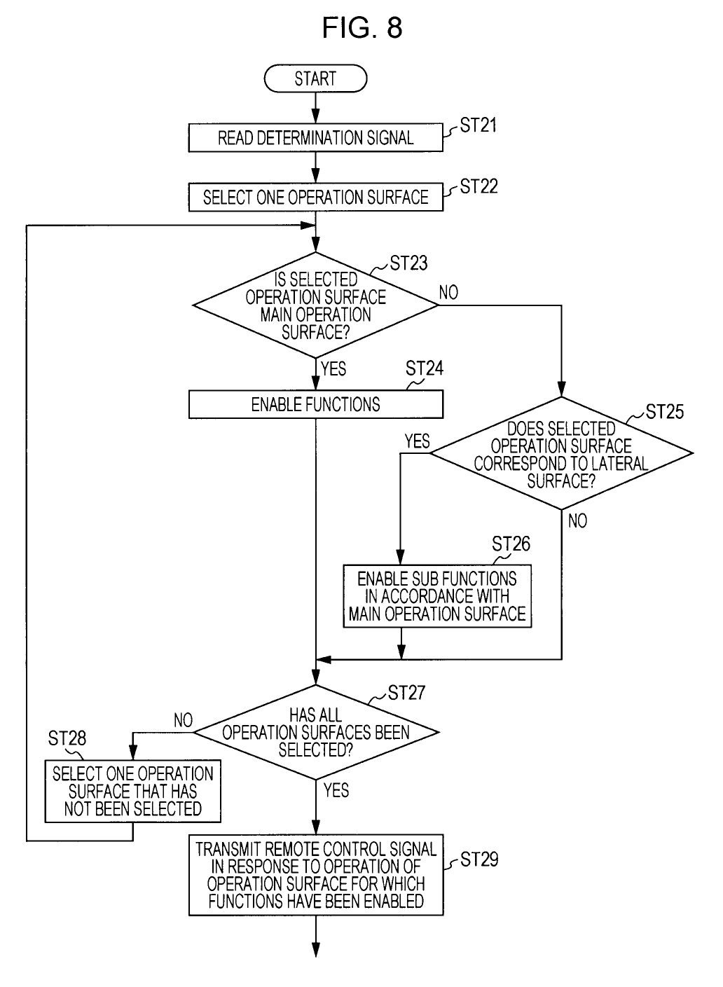

FIG. 8 is a flowchart showing an operation for selectively enabling the sub-functions in accordance with what functions are defined as the main functions.

In step ST21, the control section 41 reads a determination signal from the main operation surface determination signal generation section 31, and proceeds to step ST22.

In step ST22, the control section 41 selects one operation surface. The control section 41 selects one of the plurality of operation surfaces 12-1 to 12-6, and proceeds to step ST23.

In step ST23, the control section 41 determines whether or not the selected operation surface is the main operation surface (the top surface of the housing). If the selected operation surface is the main operation surface as determined on the basis of the determination signal, the control section 41 proceeds to step ST24. If the selected operation surface is not the main operation surface as determined on the basis of the determination signal, the control section 41 proceeds to step ST25.

In step ST24, the control section 41 enables the functions assigned to the selected operation surface. That is, the control section 41 defines the selected operation surface as an operation surface for which a remote control signal for the control functions is transmitted in response to an operation by the user, and proceeds to step ST27.

In step ST25, the control section 41 determines whether or not the selected operation surface corresponds to a lateral surface. When the main operation surface is assumed to be the top surface as discussed above, operation surfaces adjacent to the main operation surface are assumed to be lateral surfaces. Thus, if it is determined that the selected operation surface corresponds to a lateral surface, that is, the selected operation surface is adjacent to the main operation surface, the control section 41 proceeds to step ST26. If it is determined that the selected operation surface does not correspond to a lateral surface, that is, the selected operation surface is not adjacent to the main operation surface, the control section 41 proceeds to step ST27.

In step ST26, the control section 41 enables the sub-functions in accordance with the control functions assigned to the main operation surface. The control section 41 enables the sub-functions in accordance with the main functions, which are the control functions assigned to the main operation surface, as shown in FIG. 7, and proceeds to step ST27.

In step ST27, the control section 41 determines whether or not all the operation surfaces have been selected. If there remain any operation surfaces yet to be selected, the control section 41 proceeds to step ST28. If all the operation surfaces have been selected, the control section 41 proceeds to step ST29.

In step ST28, the control section 41 selects one of the operation surfaces yet to be selected, and returns to step ST23.

In step ST29, the control section 41 transmits a remote control signal in response to an operation of the operation surface for which the functions have been enabled. That is, when an operation button on the operation section provided on the operation surface for which the functions have been enabled is operated, the control section 41 generates a remote control signal indicating a command allowing execution of the control function assigned to the operated operation button. Then, the control section 41 causes the operation sections 52-1 to 52-6 to transmit the generated remote control signal.

By selectively enabling the sub-functions assigned to the lateral surfaces in accordance with the main functions assigned to the main operation surface as described above, the control functions assigned to the surfaces other than the main operation surface may be enabled in such a way that operations undesirable for the purpose of the main functions may not be performed by remote control.

Further, the control section 41 may change the control functions assigned to the operation section provided on a function-enabled surface in accordance with the control functions assigned to the operation section provided on the main operation surface. For example, when the main functions assigned to the main operation surface are the channel operation functions, the menu navigation functions assigned to the operation surface 12-3 may provide control functions for menu navigation associated with a television set. When the main functions assigned to the main operation surface are the DVD operation functions, the menu navigation functions assigned to the operation surface 12-3 may provide control functions for menu navigation associated with a DVD device.

In this way, the control functions may be optimized in accordance with the main functions even with the same operation surfaces, allowing efficient use of the operation surfaces and allowing various operations to be easily performed by remote control.

While the above remote control device 10 includes a regular hexahedral housing 11 in which operation sections are disposed on respective surfaces, the shape of the housing is not limited to a regular hexahedral shape, and may be other three-dimensional shapes. The operation sections are not limited to those for outputting an infrared signal, and may be those for outputting a radio wave.

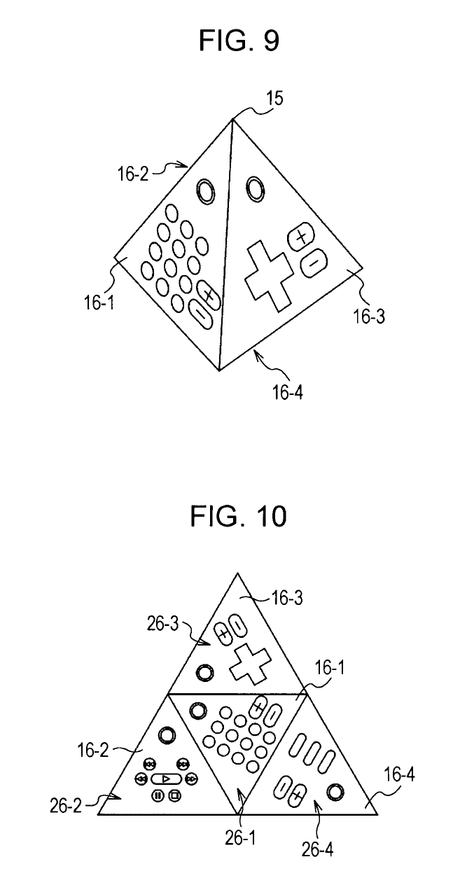

Now, a description is made of a remote control device 10a in the shape of a regular tetrahedron, for example. FIG. 9 shows the appearance of the remote control device 10a. The surfaces of a regular tetrahedral housing 15 are referred to as operation surfaces 16-1 to 16-4, respectively provided with operation sections 26-1 to 26-4 each assigned with control functions for remote control operation. The control functions for remote control operation are grouped so that the control functions for remote control operation belonging to each group are assigned to each operation section.

FIG. 10 is a developed view showing the operation surfaces 16-1 to 16-4 of the remote control device 10a. The operation surface 16-1 is used to change channels of a television set, for example. The operation surface 16-1 is provided with an operation section 26-1 including a channel-up button, a channel-down button and numeric buttons.

The operation surface 16-2 is used to operate a DVD device, for example. The operation surface 16-2 is provided with an operation section 26-2 including a playback button, a stop button, a pause button, a fast-forward button and a fast-reverse button.

The operation surface 16-3 is used to navigate through the menus of a television set, for example. The operation surface 16-3 is provided with an operation section 26-3 including a cross-shaped key and a determination button.

The operation surface 16-4 is used to adjust audio from a television set, for example. The operation surface 16-4 is provided with an operation section 26-4 including a volume-up button, a volume-down button and a sound quality mode selection button. The operation sections 26-1 to 26-4 each have a power button.

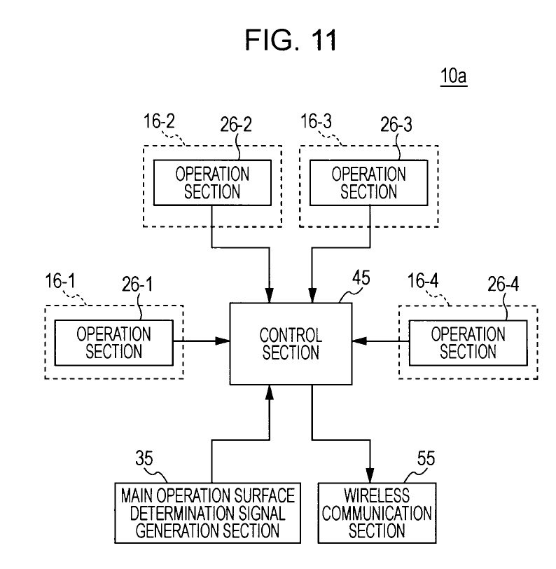

FIG. 11 shows the configuration of the remote control device 10a. The operation sections 26-1 to 26-4 each generate an operation signal according to an operation by a user, and supply the operation signal to a control section 41.

A main operation surface determination signal generation section 35 generates a determination signal for setting one of the surfaces in a predetermined direction as a main operation surface irrespective of the orientation of the housing 15. The main operation surface may be a surface that is most easily operable by a user who operates the operation section. For example, when the housing 15 is in the shape of a regular tetrahedron, a surface facing the user may be defined as the main operation surface, for example. In order to define the surface facing the user as the main operation surface, the main operation surface determination signal generation section 35 includes imaging devices provided on the respective operation surfaces to capture images outward for face detection. The main operation surface determination signal generation section 35 supplies, as a determination signal, the face detection results obtained for each operation surface to a control section 45.

The control section 45 defines an operation surface from which a face is detected as the main operation surface on the basis of the determination signal generated by the main operation surface determination signal generation section 35, generates a remote control signal for the control functions assigned to the operation section provided on the main operation surface in response to an operation of the operation section, and supplies the remote control signal to a wireless communication section 55.

The wireless communication section 55 converts the remote control signal into a radio frequency (RF) signal to output a radio wave from an antenna. The wireless communication section 55 performs wireless communication in accordance with the IEEE 802.15.4 standard, for example, to transmit the remote control signal as a radio rave. The wireless communication section 55 may use infrared radiation to transmit the remote control signal with wide directivity, allowing the remote control signal to be supplied to an operation target without providing a transmission section on each operation surface.

The remote control device 10a configured in this way allows various operations to be easily performed by remote control as with the remote control device 10 in the shape of a regular hexahedron. Also with the remote control device 10a, not only the main operation surface but also other surfaces may be used for remote control operation by using the processes shown in the flowcharts of FIGS. 5, 6 and 8. In the case where the remote control device is in the shape of a regular tetrahedron, the surfaces adjacent to the main operation surface include the bottom surface. Thus, when the main operation surface determination signal generation section 31 shown in one of FIGS. 4A to 4E is used, the control functions assigned to the bottom surface may be disabled on the basis of the determination signal generated by the main operation surface determination signal generation section 31.

The remote control device is not limited to the above configurations. For example, the remote control device 10 may be provided with a wireless communication section 55, and the remote control device 10a may be provided with a transmission section for outputting an infrared signal on each operation surface. It is a matter of course that the remote control device may be formed in the shape of other polyhedrons.

The present application contains subject matter related to that disclosed in Japanese Priority Patent Application JP 2008-170365 filed in the Japan Patent Office on Jun. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A remote control device comprising:
a polyhedral housing;
an operation section provided on each of a plurality of surfaces of the housing;
a main operation surface determination signal generation section for generating a determination signal for setting one of the surfaces in a predetermined direction as a main operation surface irrespective of an orientation of the housing;
a transmission section for transmitting a remote control signal; and
a control section for setting the main operation surface on the basis of the determination signal, generating a remote control signal for a control function assigned to the operation section provided on the main operation surface in response to an operation of the operation section, and causing the transmission section to transmit the remote control signal.

2. The remote control device according to claim 1, wherein the control section classifies the surfaces other than the main operation surface into function-enabled surfaces and function-disabled surfaces with reference to a position of the main operation surface to generate a remote control signal for a control function assigned to the operation section provided on a surface classified as a function-enabled surface in response to an operation of the operation section.

3. The remote control device according to claim 2, wherein the control section performs classification into function-enabled surfaces and function-disabled surfaces in accordance with a control function assigned to the operation section provided on the main operation surface to generate a remote control signal for a control function assigned to the operation section provided on a surface classified as a function-enabled surface in response to an operation of the operation section.

4. The remote control device according to claim 3, wherein the control section changes a control function assigned to the operation section provided on a surface classified as the function-enabled surface in accordance with a control function assigned to the operation section provided on the main operation surface.

5. The remote control device according to claim 1, wherein the surface in the predetermined direction is a surface that is most easily operable by a user who operates the operation section.

6. The remote control device according to claim 5,
wherein the surface in the predetermined direction is a top surface of the housing,
the main operation surface determination signal generation section generates a signal allowing determination of the top surface of the housing as the determination signal, and
the control section determines the top surface of the housing on the basis of the determination signal to set the top surface as the main operation surface.

7. The remote control device according to claim 5,
wherein the surface in the predetermined direction is a surface facing the user,
the main operation surface determination signal generation section generates a signal allowing determination of which direction the user is in relative to the housing, and
the control section determines a surface of the housing facing the user on the basis of the determination signal to set the determined surface as the main operation surface.

8. A remote control method comprising the steps of:
generating a determination signal for setting one of surfaces of a polyhedral housing in a predetermined direction as a main operation surface irrespective of an orientation of the housing;
setting the main operation surface on the basis of the determination signal and generating a remote control signal for a control function assigned to an operation section provided on the main operation surface in response to an operation of the operation section; and
transmitting the generated remote control signal.
